(19) United States
(12) Patent Application Publication
(10) Pub. No.: US 2024/0394786 A1
(43) Pub. Date: Nov. 28, 2024

(54) System and Method for Providing Virtual Premises

(71) Applicant: Kwun Yiu MAK, Shatin (HK)

(72) Inventor: Kwun Yiu MAK, Shatin (HK)

(21) Appl. No.: 18/269,283

(22) PCT Filed: Aug. 17, 2022
(86) PCT No.: PCT/CN2022/113058

§ 371 Date: Jun. 22, 2023

(51) Int. Cl. G06Q 30/0601; G06Q 30/0241; G06T 19/00

(52) U.S. Cl. CPC G06Q 30/0643; G06Q 30/0277; G06T 19/006

(57) ABSTRACT

A system for use by a user to provide a virtual premises. The system comprises a handheld scanning device operated by the user to scan a real-world item to capture item data characterizing one or more physical features of the real-world item. A modelling processor receives the item data and generates a 3-dimensional model of the real-world item from the item data. A gaming engine receives the 3-dimensional model of the real-world item to generate a virtual premises including a virtual item based on the 3-dimensional model of the real-world item. An information database stores item information related to the real-world item and correlated to the virtual item. A patron device is operated by a patron to visit the virtual premises and to perform an action based on the item information. A related method is also provided.

### FIELD OF THE INVENTION

The invention relates to systems for providing virtual premises. The invention is herein described by reference to systems for providing virtual premises in the form of virtual stores accessible by patrons through the internet, but the invention is not limited to this particular application.

### BACKGROUND OF THE INVENTION

It is advantageous for owners and operators of real-world premises, such as stores, places of interest, culturally significant sites, and tourist attractions, to provide an online offering, typically in the form of an e-commerce platform.

The online offering provides an alternative for patrons where it is impractical or inconvenient for the patron to physically visit the real-world premises. The online offering also provides an additional channel through which the owner or operator can market goods or services. The online offering can in turn drive patrons to physically visit the real-world premises. Likewise, patrons visiting the real-world premises can be encouraged to also visit the online offering. This mutual marketing effect of driving patrons from one to the other can increase overall patronage and revenue for the owner or operator.

Real-world premises are also costly, capital-intensive endeavors. This limits the scope for establishing such premises in terms of number and location. Stocking real-world premises with products can also be costly and inefficient especially with quickly changing product lines and/or different product lines in different locations. An online offering provides flexibility in this regard.

Online offerings range from basic e-commerce portals to functionally rich website experiences. An online offering that closely mimics the real-world experience provided by physically visiting the real-world premises should result in a better connection to the real-world premises and would enhance the mutual marketing effect mentioned above.

The quality of the online offering and experience is typically limited by the marketing budget of the owner or operator, and also by the time available to the owner or operator to devote to developing the online offering. Technological limitations, such as limitations in hardware, software, and network capabilities, are also a factor. Usually, a higher quality online offering will require greater investment in time and money to acquire the necessary technology to deliver such an online offering.

It is an object of the present invention to overcome or ameliorate at least one of the disadvantages of the prior art, or to provide a useful alternative.

### SUMMARY OF THE INVENTION

Embodiments of the present invention in a first aspect provide a system for use by a user to provide a virtual premises, the system comprising:
a handheld scanning device operated by the user to scan a real-world item to capture item data characterizing one or more physical features of the real-world item;
a modelling processor for receiving the item data and generating a 3-dimensional model of the real-world item from the item data;
a gaming engine for receiving the 3-dimensional model of the real-world item to generate a virtual premises including a virtual item based on the 3-dimensional model of the real-world item;
an information database for storing item information related to the real-world item and correlated to the virtual item; and
a patron device operated by a patron to visit the virtual premises and to perform an action based on the item information.

Embodiments of the present invention in a second aspect provide a method for a user to provide a virtual premises, the method comprising:
the user scanning a real-world item with a handheld scanning device to capture item data characterizing one or more physical features of the real-world item;
generating a 3-dimensional model of the real-world item from the item data;
generating a virtual premises including a virtual item based on the 3-dimensional model of the real-world item;
storing item information related to the real-world item and correlated to the virtual item; and
performing an action based on the item information upon an instruction from a patron visiting the virtual premises.

Embodiments of the present invention in a third aspect provide a non-transitory computer readable medium storing a program for a user to provide a virtual premises, the program comprising instructions for performing the method comprising:
receiving item data characterizing one or more physical features of a real-world item captured by the user scanning the real-world item with a handheld scanning device;
generating a 3-dimensional model of the real-world item from the item data;
generating a virtual premises including a virtual item based on the 3-dimensional model of the real-world item;
storing item information related to the real-world item and correlated to the virtual item; and
performing an action based on the item information upon an instruction from a patron visiting the virtual premises.

Other features and embodiments of the present invention can be found in the appended claims.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF THE FIGURES

Preferred embodiments in accordance with the best mode of the present invention will now be described, by way of example only, with reference to the accompanying figures, in which the same reference numerals refer to like parts throughout the figures unless otherwise specified, and in which:

FIG. 1 is a flow diagram of features of a system in accordance with an embodiment of the present invention;

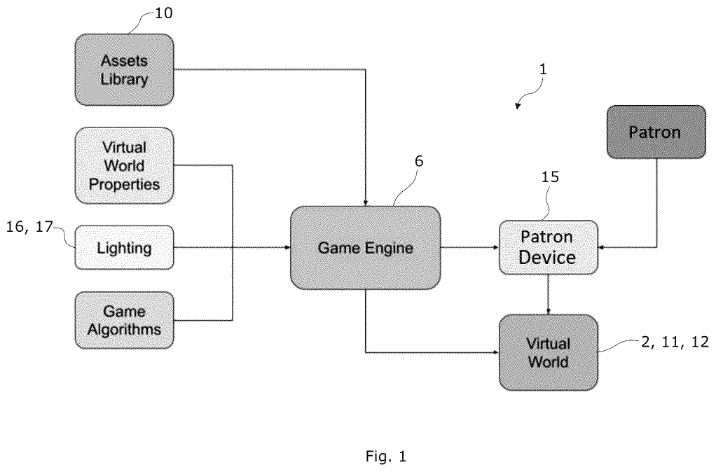

FIG. 2 is a flow diagram of further features of a system in accordance with an embodiment of the present invention;

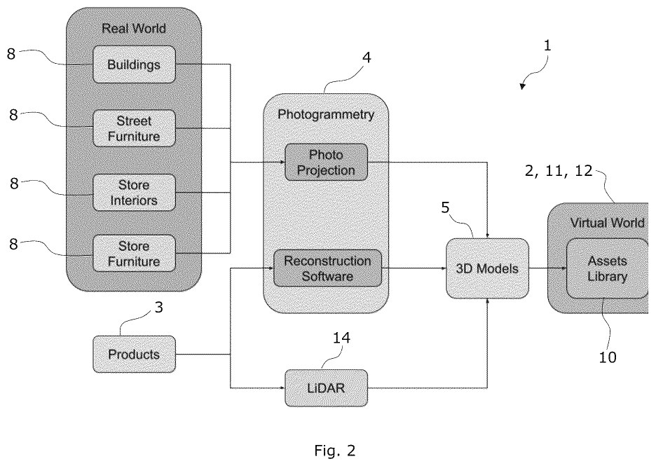

FIG. 3 is a flow diagram of other features of a system in accordance with an embodiment of the present invention;

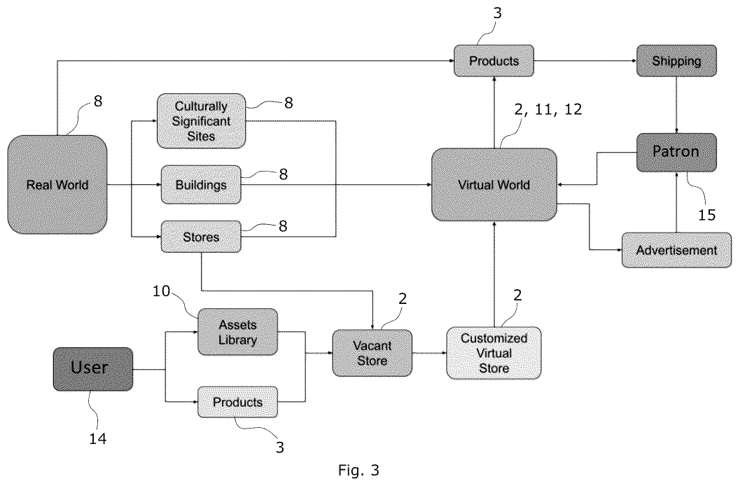

FIG. 4 is a screen capture of a patron's view of a virtual store in accordance with an embodiment of the present invention;

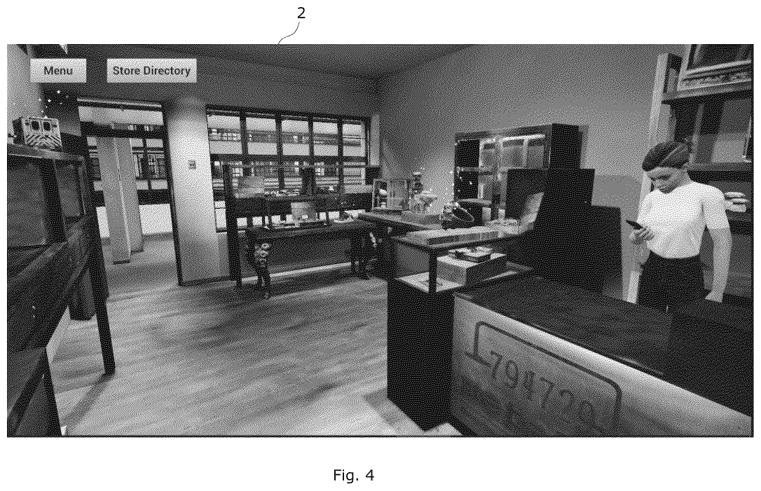

FIG. 5 is a screen capture of a patron's view of a virtual item selected by a patron in a virtual store in accordance with an embodiment of the present invention;

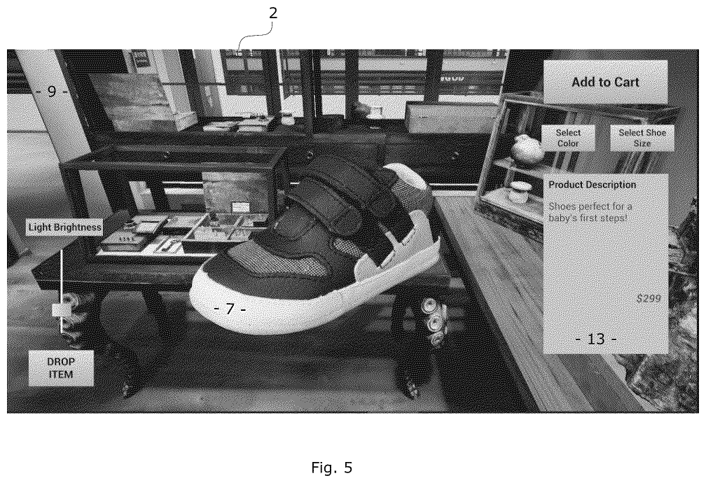

FIG. 6 is a screen capture of a patron's view of another virtual item selected by a patron in a virtual store in accordance with an embodiment of the present invention;

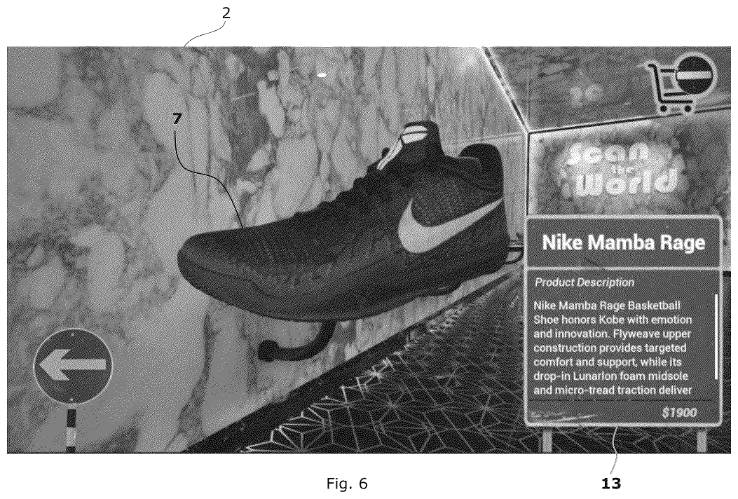

FIG. 7 is a screen capture of a patron's view of a virtual store in accordance with an embodiment of the present invention;

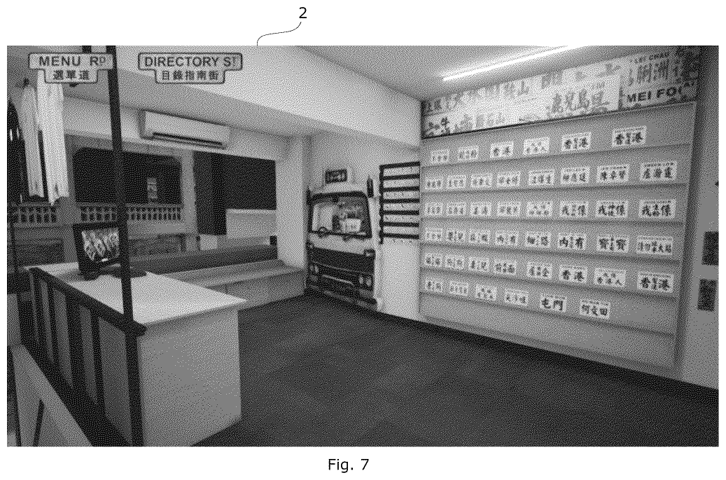

FIG. 8 is a screen capture of a patron's view of a virtual store in accordance with an embodiment of the present invention;

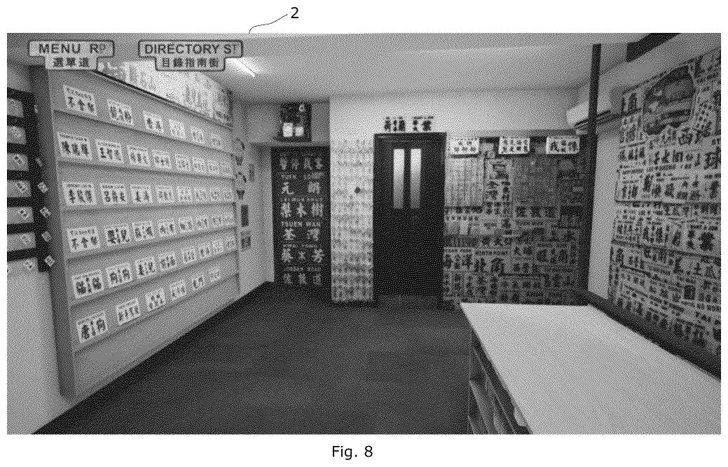

FIG. 9 is a screen capture of a patron's view of a virtual item selected by a patron in a virtual store in accordance with an embodiment of the present invention;

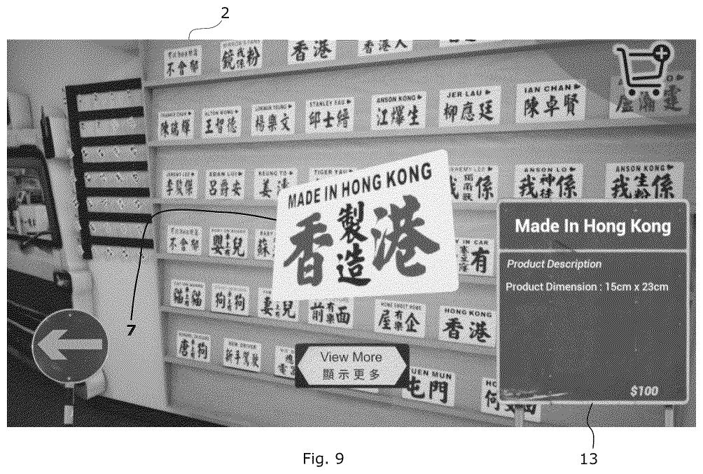

FIG. 10 is a screen capture of a user's view of a virtual premises whilst selecting virtual components for generating the virtual premises in accordance with an embodiment of the present invention;

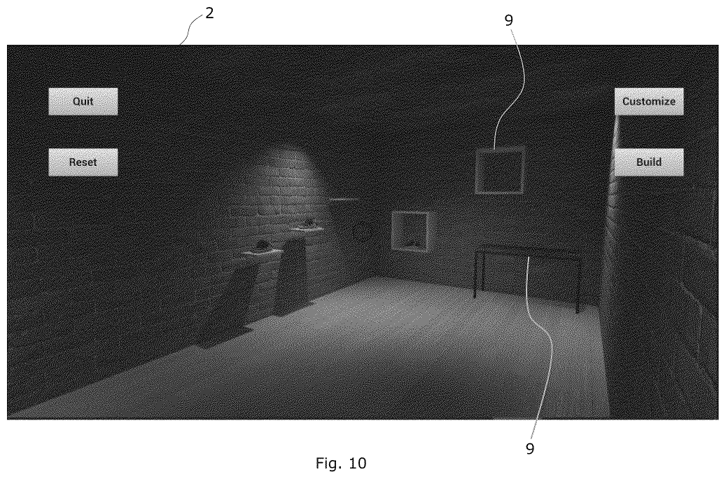

FIG. 11 is a screen capture of a user's view of the virtual premises of FIG. 10 whilst placing virtual components in the virtual premises in accordance with an embodiment of the present invention

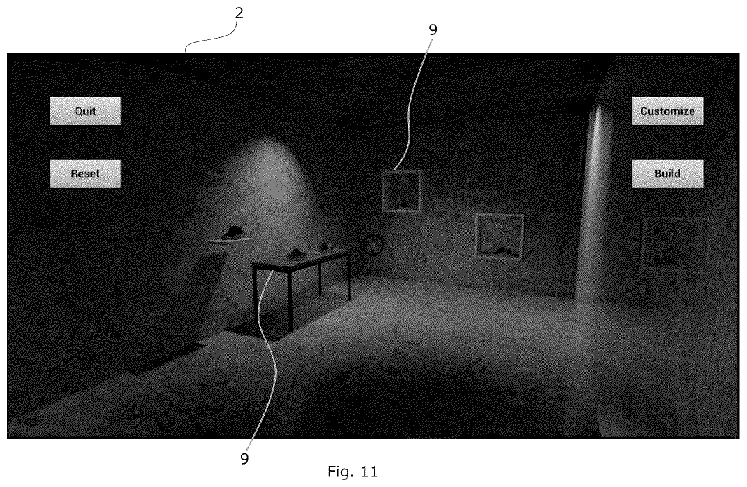

FIG. 12 is a screen capture of a patron's view of a virtual building in accordance with an embodiment of the present invention;

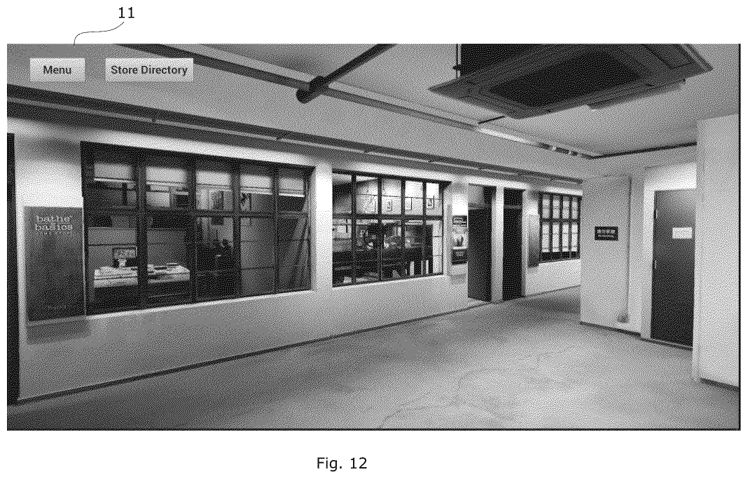

FIG. 13 is a screen capture of a patron's view of a virtual streetscape in accordance with an embodiment of the present invention;

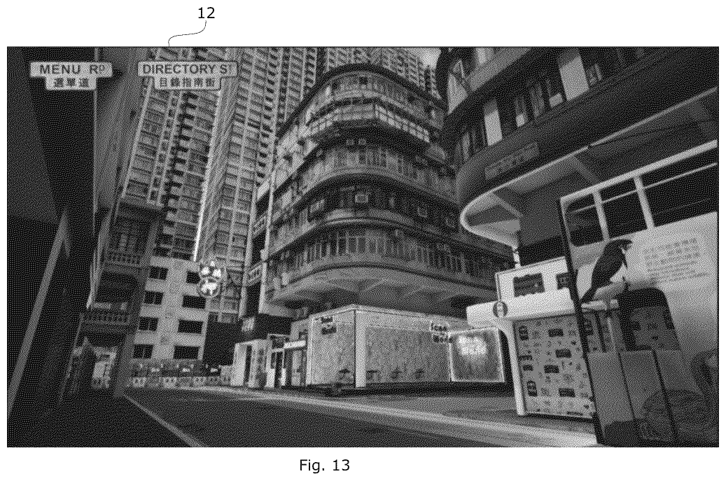

FIG. 14 is a screen capture of a patron's view of another virtual streetscape in accordance with an embodiment of the present invention; and

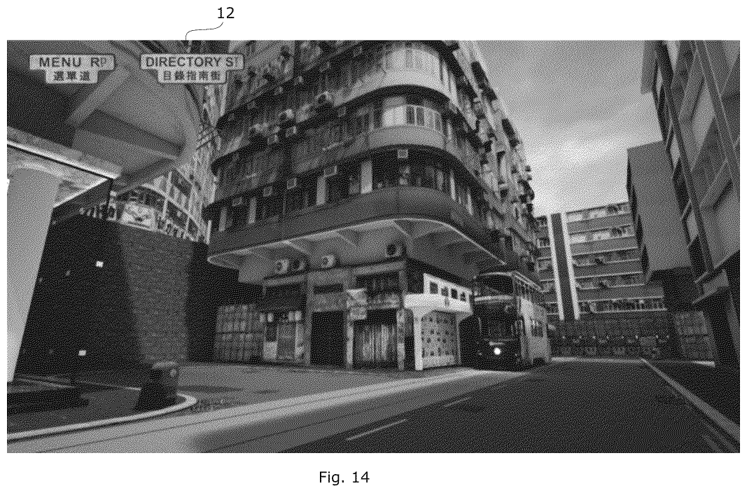

FIG. 15 is a screen capture of a patron's view of yet another virtual streetscape in accordance with an embodiment of the present invention.

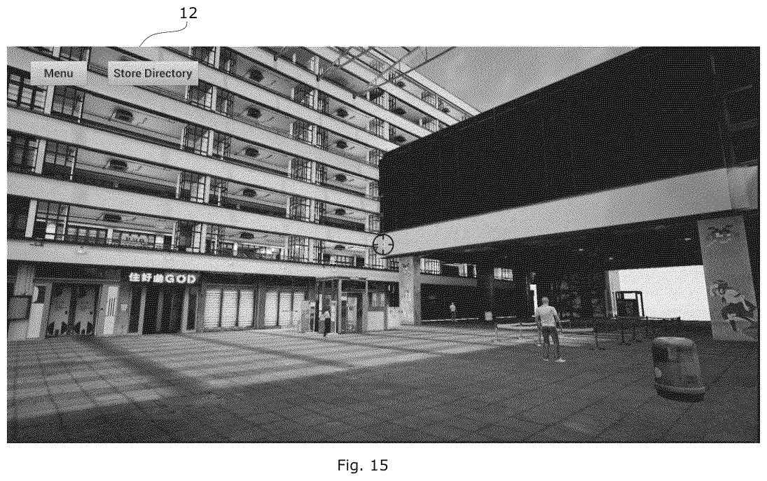

### DETAILED DESCRIPTION OF PREFERRED EMBODIMENTS OF THE INVENTION

With reference to the figures, there is provided a system 1 for use by a user to provide a virtual premises 2. The system 1 comprises a handheld scanning device 14 operated by the user to scan a real-world item 3 to capture item data characterizing one or more physical features of the real-world item. A modelling processor 4 receives the item data and generates a 3-dimensional model 5 of the real-world item from the item data. A gaming engine 6 receives the 3-dimensional model 5 of the real-world item to generate a virtual premises 2 including a virtual item 7 based on the 3-dimensional model 5 of the real-world item. An information database stores item information 13 related to the real-world item and correlated to the virtual item 7. A patron device 15 is operated by a patron to visit the virtual premises 2 and to perform an action based on the item information 13.

An advantage of the system 1 is that a user such as the owner or operator of a real-world premises does not need to have any specialist knowledge, equipment, hardware, or software to provide the virtual premises 2. The user only needs a handheld scanning device 14 and this can be a camera or lidar device in the user's smartphone. The modelling processor 4 can be located remotely from the handheld scanning device of the user and accessible through an app on the handheld scanning device or the smartphone containing the handheld scanning device. The gaming engine 6 can be located remotely from the handheld scanning device of the user and accessible through an app on the handheld scanning device or the smartphone containing the handheld scanning device. The information database can also be located remotely from the handheld scanning device of the user and accessible through an app on the handheld scanning device or the smartphone containing the handheld scanning device. One or more of the modelling processor 4, the gaming engine 6, and the information database can be located on one or more servers remotely accessible by an app on the handheld scanning device or the smartphone containing the handheld scanning device.

The patron device 15 can also be a smartphone operated by the patron. The patron can visit the virtual premises 2 through an app on the patron device. In particular, the app on the patron device 15 can connect to the gaming engine 6 so that the patron can navigate through the virtual premises 2 and perform an action such as selecting the virtual item 7 or purchasing the virtual item 7. The gaming engine 6 is typically located on a remote server accessible by the app on the patron device 15.

The purchase of the virtual item 7 can be based on item information 13 correlated to the virtual item on the information database such as price, availability, and/or place of manufacture of the real-world item 3 and trigger the real-world purchase of the real-world item on which the virtual item 7 is based. The app on the patron device 15 can include e-commerce functionality in order to fulfil the purchase of the real-world item triggered by the purchase of the virtual item 7 in the virtual premises 2.

In the foregoing embodiment, the real-world item 3 is a product and the item information 13 allows the patron to purchase the product. However, the virtual premises can be a tourist attraction or a cultural site such as a museum or an art gallery, and the real-world item 3 can be, for example, a real-world artefact displayed in a real-world museum. In these cases, the item information 13 can be in respect of one or more of the following: description; origin; and history. For example, the action performed by the patron can be selecting the virtual item 7 in the form of an artefact displayed in a virtual museum and reviewing information on the origin and/or history of the artefact, and/or a description of the artefact.

The handheld scanning device 14 is also operated by the user to scan a real-world component 8 of a real-world premises to capture component data characterizing one or more physical features of the real-world component. The modelling processor 4 receives the component data and generates a 3-dimensional model 5 of the real-world component from the component data. The gaming engine 6 receives the 3-dimensional model 5 of the real-world component to generate the virtual premises 2 including a virtual component 9 based on the 3-dimensional model 5 of the real-world component.

The item data or the component data captured by the scan can be data related to dimension, shape, texture, colour, or any other physical feature of the real-world item or component that can be characterized and captured by the handheld scanning device.

Therefore, in a similar process to scanning a real-world item as described above, the user can also scan real-world components such as one or more of the following: a structural component; a fixture; and a piece of furniture. This allows the user to build and customize the virtual premises with virtual components corresponding to real-world components. Thus, the user can mimic a real-world premises to varying degrees.

The system 1 can comprise a component database 10 for storing one or more pre-loaded virtual components. A user device is operated by the user to select one or more of the pre-loaded virtual components. The gaming engine 6 can then generate the virtual premises having the selected virtual components. This can be an alternative to user having to scan real-world components to generate virtual components to build out the virtual premises.

The component database 10 can also store virtual components 9 based on previously generated 3-dimensional models based on component data captured from a previous scan of a real-world component 8 by a user.

The gaming engine 6 can also receive a lighting model 16 to generate the virtual premises 2 with real-world lighting effects. Lighting effects, especially those that closely reproduce real-world lighting effects, can require substantial processor resources. Lighting effect calculations involve, among other things, light source parameters and data on characteristics of the materials which the light strikes. Calculations include calculating how lights bounce and interact with the surroundings. These can be performed dynamically, that is, taking into account sun movement and the resulting movement of light and shadows. However, such calculations usually require very powerful processors, typically beyond the capacity of processors in handheld devices such as smartphones. To ameliorate this, lighting effects can be pre-calculated remotely and then sent back to a handheld device, a process in which the lighting effects are described as being “static baked”. However, even this “static baking” process is too much for handheld devices.

Therefore, in one embodiment, the lighting model 16 is generated by a remote lighting processor 17 based on virtual premises data characterizing the virtual premises, with the virtual premises data being sent to the remote lighting processor and the remote lighting processor sending the lighting model to the gaming engine once it is calculated. The remote lighting processor can be located on a much more powerful server.

The gaming engine 6 also receives live or pre-recorded audio to generate the virtual premises with real-world audio effects. The live audio can be captured by microphones placed in the real-world premises and then streamed to the gaming engine 6. The pre-recorded audio can be captured by microphones during an audio survey by the user and then uploaded to the gaming engine 6 and synchronized with actions or navigation through the virtual premises by a patron.

The above can be combined to provide a virtual premises 2 that mimics corresponding real-world items or real-world premises to varying degrees of verisimilitude. One advantage is that the 3-dimensional models generated by the system 1 can result in virtual items and/or virtual premises having a photorealistic quality. Furthermore, the 3-dimensional models generated by the system 1 can result in virtual items and/or virtual premises that mimic particular real-world items and/or particular real-world premises selected by the user. This provides an online offering and patron experience that closely mimics the real-world experience provided by physically visiting the real-world premises and should therefore result in a better connection to the real-world premises, significantly enhancing the mutual marketing effect mentioned above.

The virtual premises can form part of a virtual environment. The virtual environment can comprise one or more of the following: a building 11; a streetscape 12; a neighbourhood; and a city. As for the virtual premises 2 as described above, the user can scan real-world components of the real-world environment to allow the gaming engine 6 to generate a virtual environment. The virtual environment can be generated to mimic a particular real-world environment, including lighting and audio effects. Such a virtual environment would further enhance the mutual marketing effect mentioned above. A patron, for example, could visit a virtual city that mimics a real-world city and browse virtual premises forming part of that virtual city.

For an owner or operator of a real-world premises, the system 1 can provide a virtual premises that looks and feels the same as the real-world premises. Such a virtual premises can even be located in the same location in a virtual environment such as a virtual city that mimics the real-world city in which the real-world premises is actually located. Alternatively or additionally, the virtual premises that mimic the real-world premises can be located in a different real-world city to which the real-world premises is actually located. This would allow the owner or operator to provide a patron the experience of visiting their real-world premises in a different city to which their real-world premises is actually located. This could be a way in which the owner or operator can test the viability or popularity of their real-world premises in a different location to the actual real-world location before committing to the expense of actually establishing a real-world premises in that different location.

The virtual premises can includes a virtual portal, with the patron being transported to a second virtual premises when the patron selects the virtual portal. The virtual portal can be in the form of an advertisement related to the second virtual premises. The patron can be represented as an avatar in the virtual premises or virtual environment to enhance the patron's experience. Alternatively, the patron can navigate through the virtual premises from the perspective of a viewport that corresponds to the patron's gaze.

The present invention also provides in another aspect a method for a user to provide a virtual premises. In one embodiment, the method comprises:
the user scanning a real-world item 3 with a handheld scanning device to capture item data characterizing one or more physical features of the real-world item;
generating a 3-dimensional model 5 of the real-world item from the item data;
generating a virtual premises 2 including a virtual item 7 based on the 3-dimensional model 5 of the real-world item;
storing item information related to the real-world item and correlated to the virtual item; and
performing an action based on the item information upon an instruction from a patron visiting the virtual premises 2.

In another aspect, the present invention provides a non-transitory computer readable medium storing a program for a user to provide a virtual premises. In one embodiment, the program comprises instructions for performing the method comprising:
receiving item data characterizing one or more physical features of a real-world item 3 captured by the user scanning the real-world item with a handheld scanning device;
generating a 3-dimensional model 5 of the real-world item from the item data;
generating a virtual premises 2 including a virtual item based on the 3-dimensional model 5 of the real-world item;
storing item information related to the real-world item and correlated to the virtual item; and

performing an action based on the item information upon an instruction from a patron visiting the virtual premises.

The program can be in the form of a downloadable app that can be purchased from an app store.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

1. A system for use by a user to provide a virtual premises, the system comprising:
a handheld scanning device operated by the user to scan a real-world item to capture item data characterizing one or more physical features of the real-world item;
a modelling processor for receiving the item data and generating a 3-dimensional model of the real-world item from the item data;
a gaming engine for receiving the 3-dimensional model of the real-world item to generate a virtual premises including a virtual item based on the 3-dimensional model of the real-world item;
an information database for storing item information related to the real-world item and correlated to the virtual item; and
a patron device operated by a patron to visit the virtual premises and to perform an action based on the item information.

2. The system according to claim 1 wherein the real-world item is a product and the item information allows the patron to purchase the product.

3. The system according to claim 1 wherein the item information is selected from a group comprising: price; place of manufacture; availability; description; origin; and history.

4. The system according to claim 1 further including using the handheld scanning device to scan a real-world component of a real-world premises to capture component data characterizing one or more physical features of the real-world component;
wherein the modelling processor receives the component data and generates a 3-dimensional model of the real-world component from the component data;
and wherein the gaming engine receives the 3-dimensional model of the real-world component to generate the virtual premises including a virtual component based on the 3-dimensional model of the real-world component.

5. The system according to claim 1 further including a component database for storing one or more pre-loaded virtual components; and
a user device operated by the user to select one or more of the pre-loaded virtual components; wherein the gaming engine generates the virtual premises having the selected virtual components.

6. The system according to claim 5 wherein the pre-loaded virtual components are selected from a group comprising: a structural component; a fixture; and a piece of furniture.

7. The system according to claim 1 wherein the gaming engine receives a lighting model to generate the virtual premises with real-world lighting effects.

8. The system according to claim 7 wherein the lighting model is generated by a remote lighting processor based on virtual premises data characterizing the virtual premises, the virtual premises data being sent to the remote lighting processor and the remote lighting processor sending the lighting model to the gaming engine.

9. The system according claim 1 wherein the gaming engine receives live or pre-recorded audio to generate the virtual premises with real-world audio effects.

10. The system according to claim 1 wherein the handheld scanning device is selected from a group comprising: a camera; and a lidar device.

11. The system according to claim 1 wherein the virtual premises forms part of a virtual environment.

12. The system according to claim 11 wherein the virtual environment is selected from a group comprising: a building; a streetscape; a neighbourhood; and a city.

13. The system according to claim 1 wherein the 3-dimensional model or the virtual premises is photorealistic.

14. The system according to claim 1 wherein the 3-dimensional model mimics the real-world item, or the virtual premises mimics a real-world premises.

15. The system according to claim 1 wherein the virtual premises includes a virtual portal, the patron being transported to a second virtual premises when the patron selects the virtual portal.

16. The system according to claim 15 wherein the virtual portal is in the form of an advertisement related to the second virtual premises.

17. A method for a user to provide a virtual premises, the method comprising:
scanning a real-world item with a handheld scanning device to capture item data characterizing one or more physical features of the real-world item;
generating a 3-dimensional model of the real-world item from the item data;
generating a virtual premises including a virtual item based on the 3-dimensional model of the real-world item;
storing item information related to the real-world item and correlated to the virtual item; and
performing an action based on the item information upon an instruction from a patron visiting the virtual premises.

18. A non-transitory computer readable medium storing a program for a user to provide a virtual premises, the program comprising instructions for performing the method comprising:
receiving item data characterizing one or more physical features of a real-world item captured by the user scanning the real-world item with a handheld scanning device;
generating a 3-dimensional model of the real-world item from the item data;
generating a virtual premises including a virtual item based on the 3-dimensional model of the real-world item;
storing item information related to the real-world item and correlated to the virtual item; and
performing an action based on the item information upon an instruction from a patron visiting the virtual premises.
